(19) United States
(12) Patent Application Publication
(10) Pub. No.: US 2025/0009057 A1
(43) Pub. Date: Jan. 9, 2025

(54) THREE-DIMENSIONAL BOUQUET

(71) Applicant: Jingyun SUN, Shenzhen City (CN)

(72) Inventor: Jingyun SUN, Shenzhen City (CN)

(21) Appl. No.: 18/451,920

(22) Filed: Aug. 18, 2023

(30) Foreign Application Priority Data
Jul. 4, 2023 (CN) 2023217352360

(51) Int. Cl. A41G 1/00; G09F 1/08

(52) U.S. Cl. CPC A41G 1/00; G09F 1/08

(57) ABSTRACT

The present application discloses a three-dimensional bouquet comprising an outer layer and one or more inner layers. The inner layer(s) is located within the outer layer. The distinguishing feature of this invention is as follows:

The outer layer forms a three-dimensional cavity that surrounds the bouquet. The cavity wall is equipped with at least two symmetrical creases, and symmetrically positioned through-holes on the left and right sides. The cavity wall is equipped with connecting components, which are strip-like structures. One end of the connecting components passes through the through-holes in the cavity wall and is fixed on the inner side of the wall. The other end is equipped with matching latches or fasteners that can interlock with each other. The left and right connecting components can enclose the outer surface of the cavity wall, using the latches or fasteners to securely lock the three-dimensional bouquet in place.

### FIELD OF THE TECHNOLOGY

The present application relates to a craft product, particularly a three-dimensional bouquet with a three-dimensional display effect.

### BACKGROUND

Traditional bouquets can be divided into two types: the first type is fresh bouquets available in the market, which are prone to withering and have a short preservation time. The second type is paper three-dimensional bouquets available in the market. The advantages of a three-dimensional bouquet are that it can provide more vivid and lifelike display and can incorporate features such as sound, light effects, recorded music, and other functionalities, making the bouquet livelier and more appealing. To facilitate transportation, paper based three-dimensional bouquets are often designed to be foldable and can be flattened for easy shipping and then transformed into a three-dimensional bouquet for display purposes.

In the prior art, Chinese Patent Application No. 202110244985.2, Publication No.: CN 114512074 A, published on May 17, 2022, with US patent priority no. U.S. Pat. No. 63,115,003, discloses a three-dimensional display item that is arranged to pop open. The three-dimensional display item includes an outer layer with printed images, one or more inner layers with printed images, and one or more elastic components that can be attached to the outer layer. The elastic components include a first elastic component, which is arranged to pop open and/or keep the three-dimensional display article in an open position. The main technical feature of this invention is the use of one or more elastic components, typically rubber bands, to bind a three-dimensional bouquet that can be unfolded from a flat state to a three-dimensional state, achieving a three-dimensional display. However, a drawback of this approach is that the elastic components, typically rubber bands, tend to deteriorate over time, especially in high-temperature environments such as during shipping by consolidated containers where the temperature can be particularly high for an extended period of time. In such cases the elastic component is more prone to becoming loose, losing its elasticity, and eventually breaking and losing its ability to maintain the three-dimensional display.

Another common solution that people have come up with is to use ribbons for wrapping and binding. Although this can solve the problems associated with rubber bands, it heavily relies on the consumer's skill in tying knots. Some people may tie a bow, while others may not know how to tie a bow, resulting in inconsistent display effects depending on the person's ability. Additionally, if someone wants to untie and store the three-dimensional bouquet, they may encounter the awkward situation of the knot being too tight and being unable to untie it.

### SUMMARY

The purpose of the present application is to provide a three-dimensional bouquet to solve the technical deficiencies mentioned in the background.

To achieve the above purpose, the present application provides the following technical solution: a three-dimensional bouquet comprising an outer layer and one or more inner layers. The inner layer(s) are located within the outer layer. The outer layer surrounds and forms a three-dimensional cavity, with at least two symmetric creases on the cavity wall and symmetric through-holes on the left and right sides of the cavity wall. The cavity wall also includes connecting members, with one end passing through the through-holes in the cavity wall and fixed on the inner side of the cavity wall. The other end of the connecting members has matching latches or fasteners, and the left and right connecting members can encircle of the outer surface of the three-dimensional bouquet and securely lock it in place at the front of the bouquet.

Furthermore, one end of the connecting components passes through the interior of the cavity and is fixed to the inner side of the opposite cavity wall.

Furthermore, the connecting components are strip-like structures made of paper or plastic.

Furthermore, the connecting components are in the form of ribbons or cords.

Furthermore, the bottom of the outer layer is also connected to a bottom cover.

Furthermore, the bottom cover is provided with a crease, which is in the same plane as the two symmetric creases on the cavity wall.

Furthermore, the bottom cover forms a polygon when unfolded.

Furthermore, the bottom cover forms an elliptical or circular shape when unfolded.

Furthermore, the inner layer(s) is also equipped with electronic devices to achieve audio and visual effects.

Furthermore, the inner layer(s) consists of multiple expandable or collapsible sheet-like components, which serve as the constituent elements of the three-dimensional bouquet.

Compared to the prior art, the present application has the following advantageous effects: By utilizing the connecting components positioned on both sides of the bouquet, this three-dimensional bouquet can be easily transformed from a flat state to a three-dimensional state. The assembly and disassembly are convenient and reliable, allowing anyone to perform the operation effortlessly. Furthermore, the production and manufacturing costs are low.

### BRIEF DESCRIPTION OF THE DRAWINGS

FIG. 1 is one of the three-dimensional schematic views of a three-dimensional bouquet described in Example 1;

FIG. 2 is another three-dimensional schematic view of a three-dimensional bouquet described in Example 1;

FIG. 3 is a front view of a three-dimensional bouquet described in Example 1, with the connecting components in the unfolded state;

FIG. 4 is a left side view of a three-dimensional bouquet described in Example 1, with the connecting components in the unfolded state;

FIG. 5 is a right side view of a three-dimensional bouquet described in Example 1, with the connecting components in the unfolded state;

FIG. 6 is a schematic diagram of the internal connection structure of the connecting components in a three-dimensional bouquet described in Example 1;

FIG. 7 is a schematic diagram of the structure of a three-dimensional bouquet being compressed into a flat state described in Example 1;

FIG. 8 is another schematic diagram of the structure of a three-dimensional bouquet described in Example 2;

FIG. 9 is another schematic diagram of the structure of a three-dimensional bouquet described in Example 3;

FIG. 10 is another schematic diagram of the structure of a three-dimensional bouquet described in Example 4;

In the figures: 1—outer layer, 2—inner layer, 3—bottom cover, 101—left connecting component, 102—right connecting component, 201—left through-hole, 103—left crease, 104—right crease, 202—right through-hole, 301—crease on the bottom cover, 1011—left connecting component latch, 1012—right connecting component latch.

### DETAILED DESCRIPTION

Below is a further detailed explanation of the technical solution of the present application, with reference to specific implementation examples.

### Example Embodiment 1

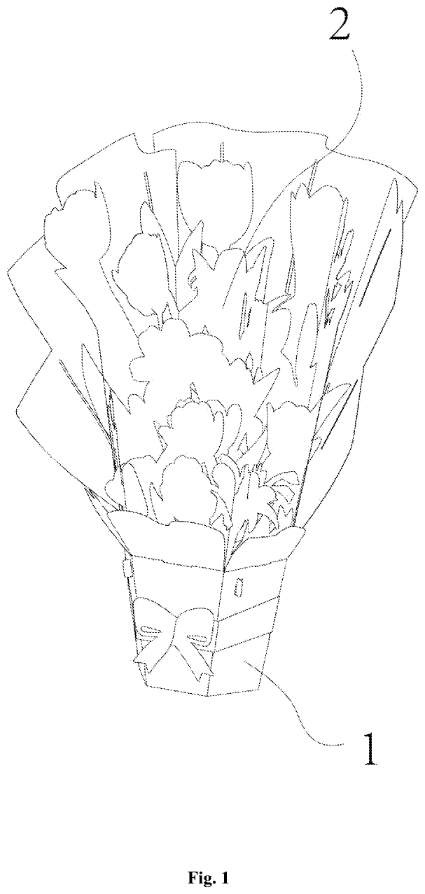

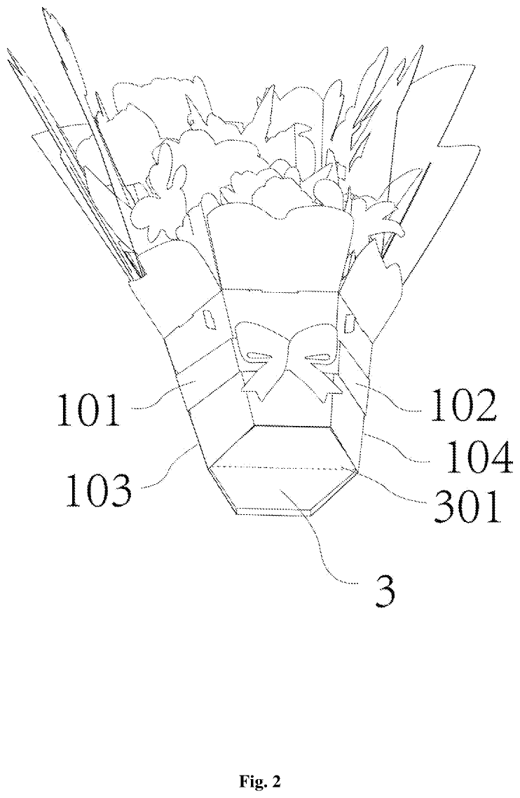

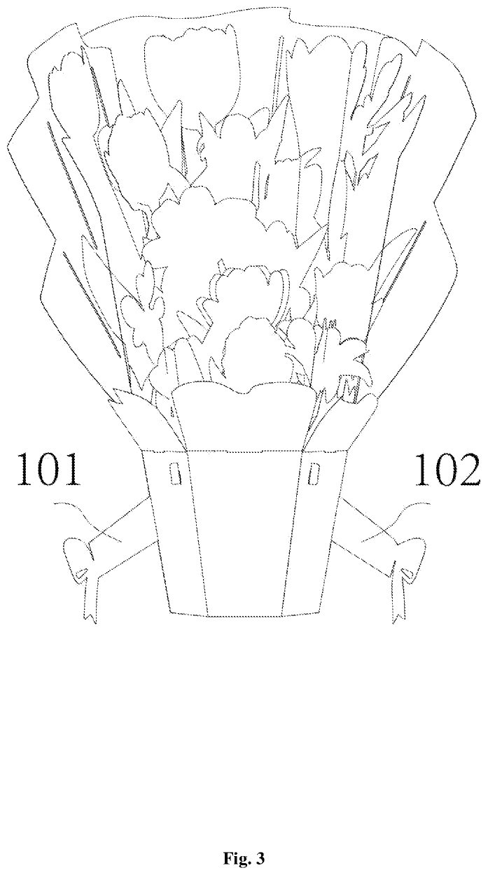

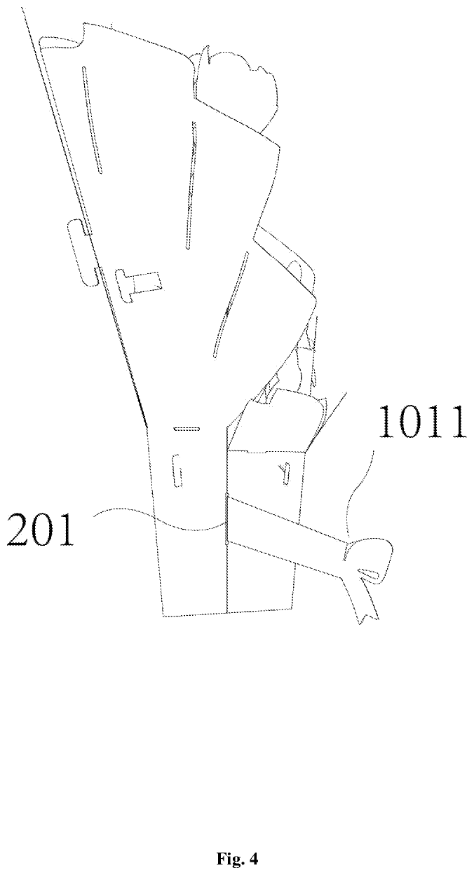

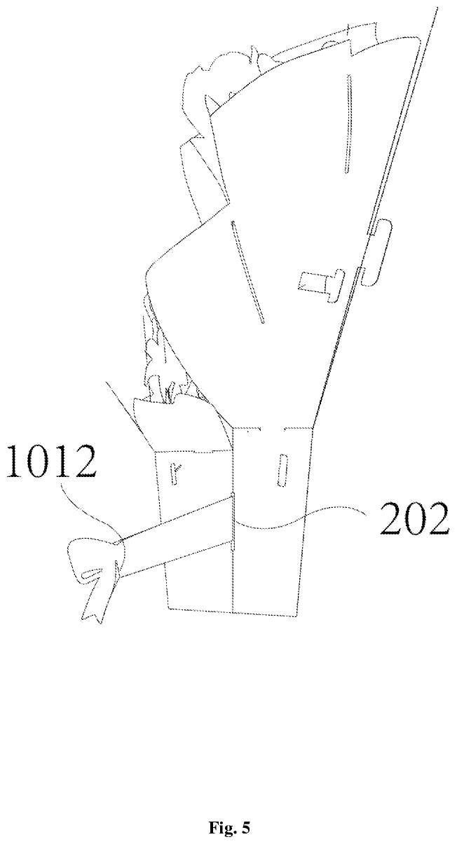

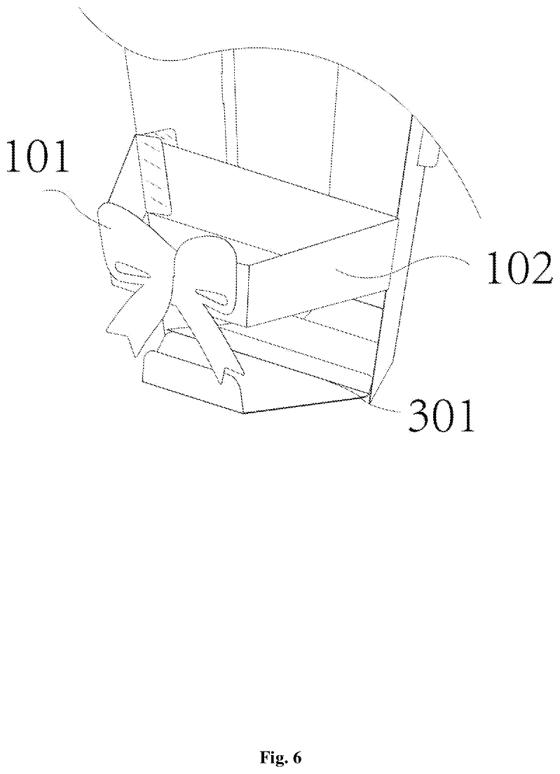

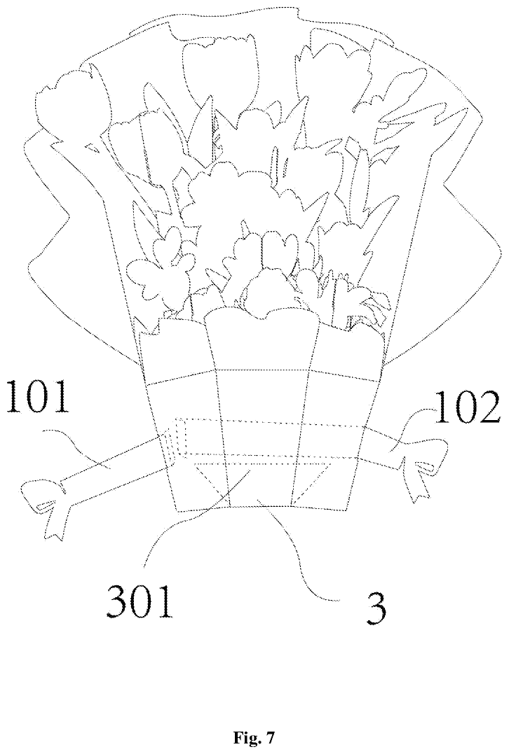

As shown in FIGS. 1 to 7, a three-dimensional bouquet is provided. It includes an outer layer 1 and an inner layer 2, where the inner layer 2 is located within the outer layer 1. The outer layer 1 surrounds and forms a three-dimensional cavity. The cavity walls have six vertically symmetrical creases. On the symmetrical creases, there are two symmetrically positioned through-holes: left through-hole 201 and right through-hole 202. The cavity walls also have two connecting components: left connecting component 101 and right connecting component 102. The connecting components are strip-like structures. One end of the left connecting component 101 passes through the left through-hole in the cavity wall and is fixed to the inside of the cavity wall near the left through-hole. One end of the right connecting component 102 passes through the right through-hole in the cavity wall, goes through the interior of the three-dimensional bouquet, and is fixed to the inside of the opposite cavity wall. The other end of the left connecting component has a matching latch 1011, and the other end of the right connecting component has a matching latch 1012. The left and right connecting components enclose the front half of the three-dimensional bouquet and are locked in place at the front of the bouquet. The connecting components can be made of strip-like paper or plastic.

The connecting components can also be replaced with ribbons, woven ribbons or cords, which are fixed by tying knots.

The bottom of the outer layer is also connected to a bottom cover 3, which is hexagonal in shape. It has a central horizontal crease which is in the same plane as the left crease 103 and right crease 104, which are symmetrically positioned on the cavity wall. When folding, the bottom covers 3 can be folded along the crease line 301.

Due to the presence of symmetrical creases on the cavity wall, namely the left crease 103 and right crease 104, the three-dimensional bouquet can be flattened along these creases, making it easier for packaging and transportation.

When using, simply stretch the left connecting component 101 and right connecting component 102. The latches 1011 on the left connecting component and 1012 on the right connecting component are engaged and locked, transforming the flattened bouquet into a three-dimensional state, achieving a pop-up three-dimensional bouquet effect.

### Example Embodiment 2

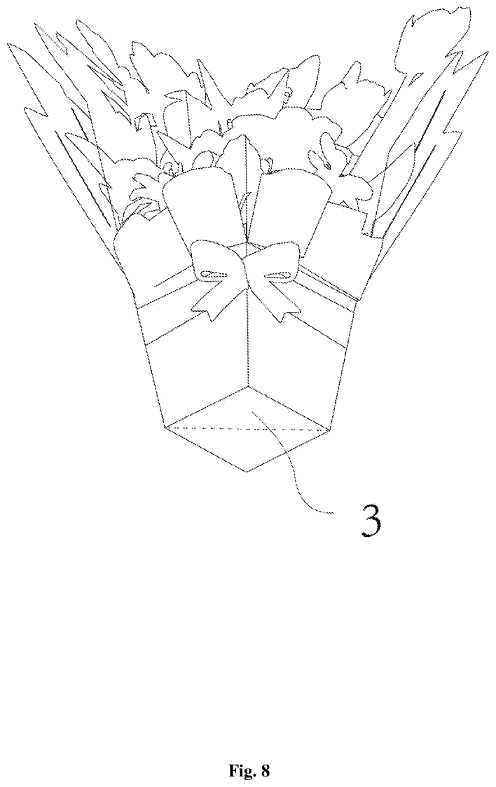

As shown in FIG. 8, to provide more examples of similar specific embodiments, different designs of the expanded bottom cover 3 are shown. FIG. 8 represents one embodiment with a quadrilateral bottom cover 3. It allows the three-dimensional bouquet to be flattened or expanded along the predetermined creased line 301.

### Example Embodiment 3

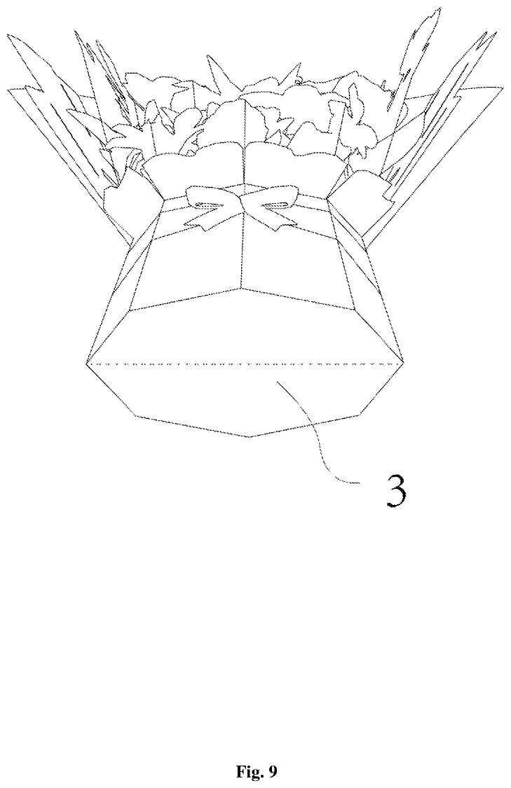

As shown in FIG. 9, to provide more examples of similar specific embodiments, different designs of the expanded bottom cover 3 are shown. FIG. 9 represents one embodiment with an octagonal bottom cover 3. It allows the three-dimensional bouquet to be flattened or expanded along the predetermined folding line 301.

### Example Embodiment 4

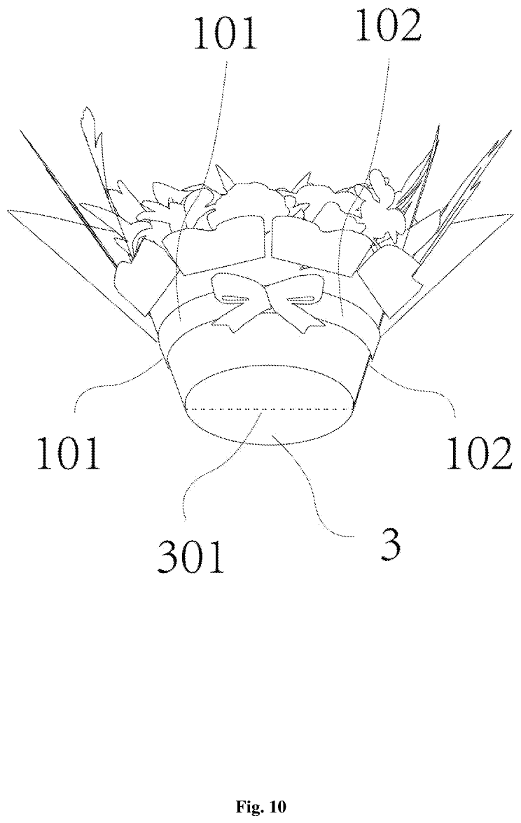

As shown in FIG. 10, there is a three-dimensional bouquet with a similar structure to Example 1. The difference lies in the circular bottom cover 3, which has a central horizontal crease line 301. It also features symmetric left crease line 103 and right crease line 104 on the external layer of the cavity wall, all of which are in the same plane. When folded, the bottom cover can be folded along the designated crease line 301.

Due to the presence of symmetrical creases on the cavity wall, namely the left crease 103 and right crease 104, the three-dimensional bouquet can be flattened along these creases, making it easier for packaging and transportation.

When using, simply stretch the left connecting component 101 and right connecting component 102. The latches on each end of the connecting components are engaged and locked, transforming the flattened bouquet into a three-dimensional state, achieving a pop-up three-dimensional bouquet effect.

As a replacement option that would be readily apparent to those skilled in the art, the bottom of the outer layer could be elliptical.

It is apparent to those skilled in the art that the present application is not limited to the details of the exemplary embodiments described above and can be implemented in other specific forms without departing from the spirit or essential characteristics of the present application. Therefore, the exemplary embodiments should be considered as illustrative and non-limiting. The scope of the present application is defined by the claims rather than the foregoing description. Thus, it is intended to encompass all variations falling within the meaning and scope of the equivalent elements of the claims. No particular figures or accompanying labels within the claims should be interpreted as limiting the rights involved.

Furthermore, it should be understood that although this specification describes the embodiments according to specific examples, not every embodiment is limited to a single independent technical solution. The manner of description in this specification is for clarity purposes only. Skilled persons in the field should consider the specification as a whole, and the technical solutions in each embodiment can be appropriately combined to form other embodiments that are understandable by skilled persons in the field.

What is claimed is:

1. A three-dimensional bouquet comprising an outer layer and one or more inner layers, with the inner layer(s) located within the outer layer, such that the outer layer surrounds and forms a three-dimensional cavity; the cavity wall has at least two symmetrical creases and symmetrically positioned through-holes on the left and right sides; the cavity wall is equipped with connecting components with one end passing through the through-holes in the cavity wall and fixed on the inner side of the cavity wall, and the other end having matching latches or fasteners; the left and right connecting components can enclose the outer surface of the three-dimensional bouquet and securely lock it into place.

2. The three-dimensional bouquet according to claim 1, wherein, one end of the connecting components passes through the interior of the cavity and is fixed to the inner side of the opposite cavity wall.

3. The three-dimensional bouquet according to claim 1, wherein the connecting components are strip-like structures made of paper or plastic.

4. The three-dimensional bouquet according to claim 1 or 2, wherein the connecting components are made of textile fabric.

5. The three-dimensional bouquet according to claim 1 or 2, wherein the bottom of the outer layer is also connected to a bottom cover.

6. The three-dimensional bouquet according to claim 5, wherein the bottom cover has a crease that is in the same plane as the two symmetrical creases on the cavity wall.

7. The three-dimensional bouquet according to claim 5, wherein the bottom cover forms a polygon when unfolded.

8. The three-dimensional bouquet according to claim 5, wherein the bottom cove forms an oval or circular shape when unfolded.

9. The three-dimensional bouquet according to any one of claims 1-8, further comprising electronic devices within the inner layer(s) to achieve audio and visual effects.

10. The three-dimensional bouquet according to any one of claims 1-8, wherein the inner layer(s) consist of multiple expandable or collapsible sheet-like components, which serve as the constituent elements of the three-dimensional bouquet.
